(19) United States
(12) Patent Application Publication
(10) Pub. No.: US 2026/0367480 A1
(43) Pub. Date: Nov. 19, 2026

(54) VARIABLE APERTURE, CAMERA MODULE, AND ELECTRONIC DEVICE

(71) Applicant: AAC Microtech (Changzhou) Co., Ltd., Changzhou City (CN)

(72) Inventors: Zhiwei Zhong, Changzhou (CN); Xin Jin, Changzhou (CN); Wei Song, Changzhou (CN); Weiwei Tao, Changzhou (CN)

(21) Appl. No.: 19/319,780

(22) Filed: Sep. 5, 2025

Related U.S. Application Data
(63) Continuation of application No. PCT/CN2025/094890, filed on May 14, 2025.

(51) Int. Cl. G03B 9/06; G03B 30/00

(52) U.S. Cl. CPC G03B 9/06; G03B 30/00

(57) ABSTRACT

A variable aperture, a camera module, and an electronic device are provided. The variable aperture includes: a base; a rotating bracket rotatably connected to the base; multiple blades rotatably connected to the base and slidably connected to the rotating bracket; and a driving mechanism for driving the rotating bracket to rotate. The base is provided with a first through hole, the rotating bracket is provided with a second through hole, and the multiple blades together define an aperture hole, with the first through hole, the second through hole, and the aperture hole being aligned. The variable aperture further includes a spring, one end of the spring is fixed relative to the rotating bracket and the other end of the spring is fixed relative to the base, and the spring is configured to provide a restoring force to drive the rotating bracket to rotate circumferentially.

### TECHNICAL FIELD

The present disclosure relates to the technical field of cameras, and more particularly to a variable aperture, a camera module, and an electronic device.

### BACKGROUND

In daily life, electronic devices such as smartphones are typically equipped with camera modules. A camera module dynamically adjusts the amount of incoming light by changing the diameter of a variable aperture, thereby adapting to various lighting conditions. The variable aperture typically includes a base, a rotating bracket, a driving mechanism, and multiple blades. The blades collectively define an aperture. The driving mechanism drives the rotating bracket, which is rotatably connected to the base, such that the rotating bracket moves the blades, each rotatably connected to the base and slidably engaged with the rotating bracket, so as to change the aperture diameter. However, when the rotating bracket is directly rotatably connected to the base, relatively high friction may exist between the rotating bracket and the base, thereby requiring greater driving force to actuate the bracket. This makes relative rotation between the rotating bracket and the base less efficient. In related technologies, ball bearings or roller bearings are provided between the rotating bracket and the base to reduce friction. While such rolling elements help lower the required driving force, their performance may degrade over time due to prolonged use or falls caused by external impacts, resulting in increased friction between the rotating bracket and the base. This leads to a risk of variation in the friction coefficient and causes instability.

Accordingly, there is a need to provide a new variable aperture.

### SUMMARY

The objective of the present disclosure is to provide a variable aperture that maintains a relatively stable and low friction coefficient between its rotating bracket and base, even after long-term use or when subjected to external impact, thereby ensuring high reliability.

The technical solution of the present disclosure is as follows.

A variable aperture is provided according to a first aspect of the present disclosure. The variable aperture includes: a base; a rotating bracket rotatably connected to the base; multiple blades rotatably connected to the base and slidably connected to the rotating bracket; and a driving mechanism for driving the rotating bracket to rotate. The base is provided with a first through hole, the rotating bracket is provided with a second through hole, and the multiple blades together define an aperture hole, with the first through hole, the second through hole, and the aperture hole being aligned. The variable aperture further includes a spring, with one end of the spring is fixed relative to the rotating bracket and the other end of the spring is fixed relative to the base, and the spring is configured to provide a restoring force to drive the rotating bracket to rotate circumferentially.

Further, the spring extends circumferentially, and/or the variable aperture further includes a plurality of such springs arranged at circumferential intervals.

In some embodiments, the driving mechanism includes: a magnet structure fixedly connected to the base; and a coil arranged around the magnet structure and fixedly connected to the rotating bracket, and configured to drive the rotating bracket to rotate.

In some embodiments, an accommodating space is formed between the base and the rotating bracket, spaced apart from the first through hole, and the driving mechanism is at least partially assembled in the accommodating space. The base is provided with a first sliding groove on its outer circumferential side, which is in communication with the accommodating space and extends circumferentially. A first sliding block protrudes axially from the rotating bracket toward the base and is configured to move along the first sliding groove. The coil is fixedly connected, on a side facing the accommodating space, to a side of the first sliding block that radially faces away from the magnet structure.

In some embodiments, a connecting protrusion protrudes axially from the base toward the rotating bracket, the connecting protrusion is at least partially located within the accommodating space, and one end of the magnet structure is fixedly connected to the connecting protrusion.

In some embodiments, the spring is partially accommodated in the accommodating space, and one end of the spring is a movable end and fixedly connected to a side of the coil that faces away from the first sliding block.

In some embodiments, the variable aperture further includes a first electrical connection board. The first electrical connection board includes: a main body arranged on a side of the base that axially faces away from the rotating bracket; and a first connecting portion protruding from the main body toward the rotating bracket. The first connecting portion is located within the first sliding groove, and the other end of the spring is a fixed end fixedly connected to a side of the first connecting portion that faces away from the accommodating space.

In some embodiments, the rotating bracket is provided on its outer peripheral side with a second sliding groove extending circumferentially. The base is provided with a second sliding block configured to move along the second sliding groove. The first electrical connection board further includes a second connecting portion protruding from the main body. The second connecting portion is arranged in parallel with and spaced apart from the first connecting portion. The second connecting portion is fixedly connected to a side of the second sliding block that faces away from the accommodating space.

In some embodiments, the variable aperture further includes a second electrical connection board fixedly connected to a side of the rotating bracket that axially faces the base. The coil is electrically connected to the second electrical connection board, the fixed end is electrically connected to the first connecting portion, and the movable end is electrically connected to the coil.

In some embodiments, the magnet structure includes a first magnet fixedly connected to the base, and a second magnet arranged at one end of the first magnet such that N poles of the first and the second magnets face each other. The driving mechanism further includes a magnetic conductor arranged on a side of the coil that faces away from the first magnet and fixedly connected to the base. The magnetic conductor at least partially extends to an end of the second magnet that faces away from the first magnet.

In some embodiments, the driving mechanism further includes at least one magnetic steel fixedly assembled between the first magnet and the magnetic conductor, and an N pole of the magnetic steel faces an S pole of the first magnet.

In some embodiments, the magnetic conductor includes a first magnetic conduction sheet arranged on the side of the coil that faces away from the first magnet, and the first magnetic conduction sheet extends in a lengthwise direction of the first magnet and extends to the end of the second magnet that faces away from the first magnet.

In some embodiments, the driving mechanism includes a first magnetic steel fixedly assembled between the first magnet and the first magnetic conduction sheet, and an N pole of the first magnetic steel faces an S pole of the first magnet.

In some embodiments, the magnetic conductor further includes a second magnetic conduction sheet connected to and arranged orthogonally with the first magnetic conduction sheet. The second magnetic conduction sheet extends in the lengthwise direction of the first magnet and extends to a middle part of the second magnet along the lengthwise direction.

In some embodiments, the driving mechanism further includes a second magnetic steel fixedly assembled between the first magnet and the second magnetic conduction sheet, and an N pole of the second magnetic steel faces the S pole of the first magnet.

In some embodiments, the driving mechanism further includes an iron core. The first magnet and the second magnet are connected via the iron core. The coil extends from the N pole of the first magnet to an end of the iron core that is remote from the first magnet.

A camera module is provided according to a second aspect of the present disclosure. The camera module includes a lens module and the variable aperture. The variable aperture is fixedly connected to the lens module and is located on the near-light side of a lens of the lens module.

An electronic device is provided according to a third aspect of the present disclosure. The electronic device includes the camera module.

The advantageous effects of the present disclosure are as follows. The variable aperture of the present disclosure includes a base, a rotating bracket, a plurality of blades, and a driving mechanism. The driving mechanism is configured to rotate the rotating bracket, which in turn drives the blades to rotate relative to the base and to slide relative to the rotating bracket. By rotating the bracket, the blades can be actuated to vary the aperture diameter formed by the blades, thereby adjusting the amount of incoming light. The variable aperture further includes a spring having one end fixed relative to the rotating bracket and the other end fixed relative to the base. Thus, when the rotating bracket rotates relative to the base, the spring correspondingly undergoes elastic deformation, thereby providing a restoring force for the relative rotation between the rotating bracket and the base. As a result, the spring can reduce the friction between the rotating bracket and the base and can balance the driving force of the driving mechanism. In addition, compared with the ball or roller bearings in the related art, the spring in the embodiments of the present disclosure exhibits less variation in elastic coefficient during mass production, thereby providing better consistency. Furthermore, even under long-term use or external impacts, the spring does not pose a risk of friction coefficient fluctuation, offering high stability and reliability.

### BRIEF DESCRIPTION OF THE DRAWINGS

In order to more clearly illustrate the technical solutions of the embodiments of the present disclosure, the drawings for describing the embodiments will be briefly introduced below. It should be understood that the drawings described below show merely some embodiments of the present disclosure, and other drawings may be derived by those skilled in the art without any inventive effort. In the drawings:

FIG. 1 is a perspective view illustrating a structure of a variable aperture in the present disclosure;

FIG. 2 is an exploded view of the variable aperture in the present disclosure;

FIG. 3 is a structural diagram of a first part of the variable aperture in the present disclosure;

FIG. 4 is a structural diagram of a second part of the variable aperture in the present disclosure;

FIG. 5 is a structural diagram of a driving mechanism in the present disclosure; and

FIG. 6 is a cross-sectional view of the driving mechanism taken along the A-A direction.

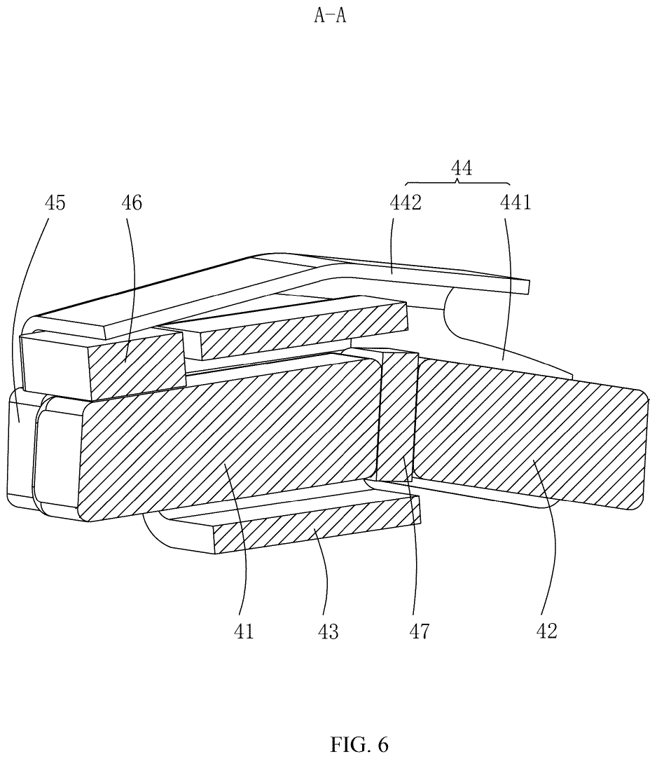

In the drawings, the reference numerals denote:
1, base; 11, first through hole; 12, first sliding groove; 13, connecting protrusion; 14, rotating shaft;
2, rotating bracket; 21, second through hole; 22, first sliding block; 23, second sliding groove; 24, second connecting post;
3, blade; 31, aperture hole; 32, rotation hole; 33, sliding hole;
4, driving mechanism; 41, first magnet; 42, second magnet; 43, coil; 44, magnetic conductor; 441, first magnetic conduction sheet; 442, second magnetic conduction sheet; 45, first magnetic steel; 46, second magnetic steel; 47, iron core;
5, spring; 51, movable end; 52, fixed end;
6, accommodating space;
7, first electrical connection board; 71, main body; 72, first connecting portion; 73, second connecting portion;
8, second electrical connection board;
9, cover; 91, third through hole.

### DETAILED DESCRIPTION OF THE EMBODIMENTS

In the description of the present application, it should be understood that the terms such as “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “circumferential”, and “radial” indicate positional or directional relationships based on those shown in the drawings. These are provided solely for the purpose of facilitating the description of the application and simplifying the explanation, and are not intended to indicate or imply that the referenced devices or components must have a particular orientation or be constructed and operated in a specific orientation. Therefore, such terms should not be construed as limiting the scope of the application.

Furthermore, the terms “first” and “second” are used merely for descriptive purposes and should not be interpreted as indicating or implying relative importance or a particular number of the referenced technical features. Features described as “first” and “second” may explicitly or implicitly include one or more such features. In the description of the present application, the term “a plurality of” means two or more, unless otherwise specifically defined.

The present application will be further described below with reference to the drawings and embodiments.

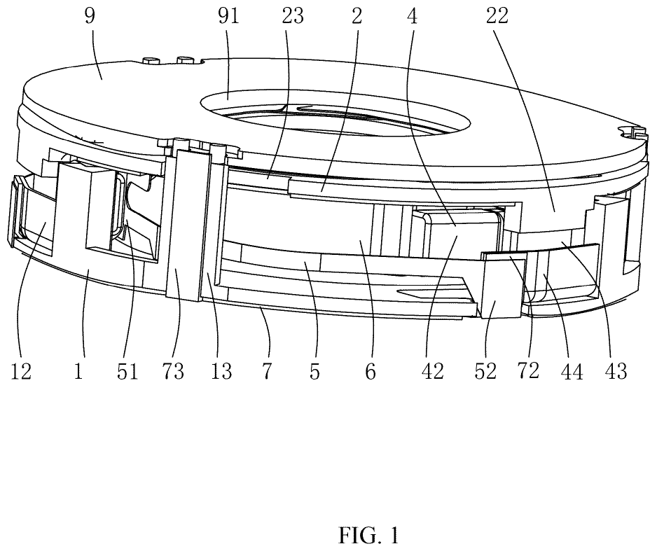

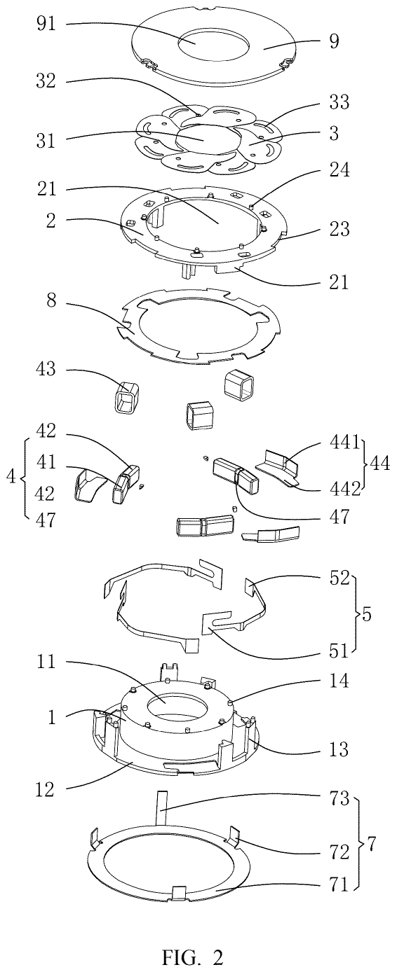

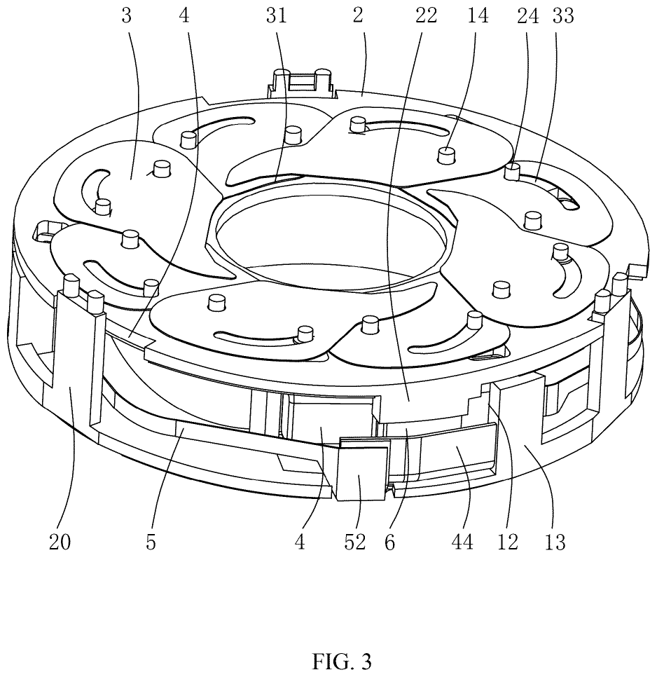

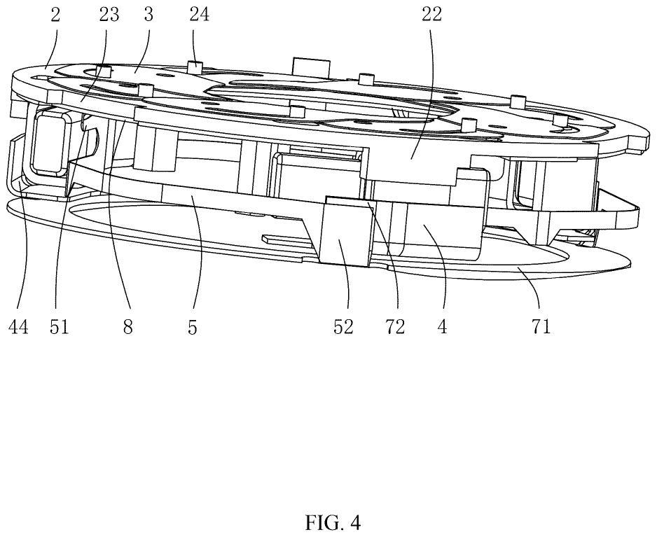

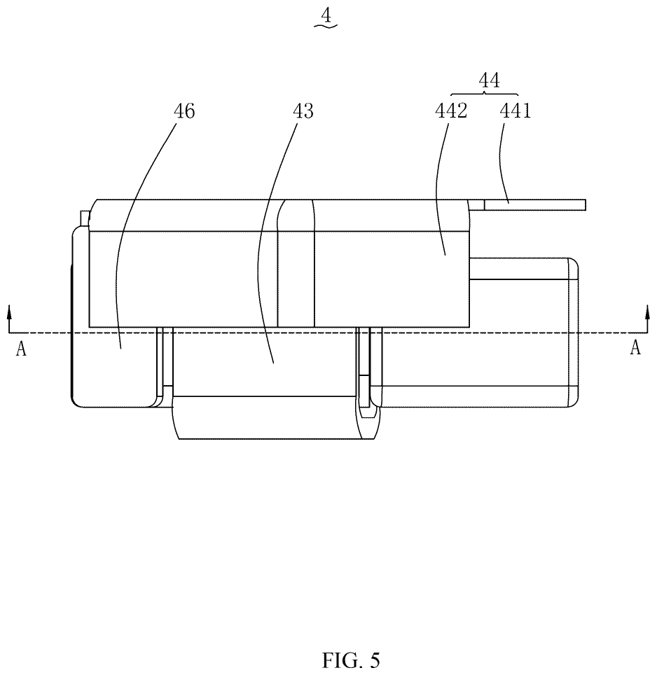

Referring to FIGS. 1 to 5, a variable aperture includes a base 1, a rotating bracket 2 rotatably connected to the base 1, a plurality of blades 3 rotatably connected to the base 1 and slidably connected to the rotating bracket 2, and a driving mechanism 4 configured to drive the rotating bracket 2 to rotate. The base 1 is provided with a first through hole 11. The rotating bracket 2 is provided with a second through hole 21. The plurality of blades 3 together defines an aperture hole 31. The first through hole 11, the second through hole 21, and the aperture hole 31 are arranged in alignment. The variable aperture further includes a spring 5, one end of which is fixed relative to the rotating bracket 2 and the other end of which is fixed relative to the base 1. The spring 5 is configured to provide a restoring force for causing the rotating bracket 2 to rotate in the circumferential direction.

In the embodiments of the present disclosure, the variable aperture includes the base 1, the rotating bracket 2, the plurality of blades 3, and the driving mechanism 4. The driving mechanism 4 is configured to drive the rotating bracket 2 to rotate, and the rotating bracket 2 is capable of driving the blades 3 to rotate relative to the base 1 and to slide relative to the rotating bracket 2. That is, by driving the rotating bracket, the plurality of blades 3 can be indirectly actuated, thereby changing the size of an aperture hole 31 enclosed by the blades 3, and further allowing control of the amount of incoming light. In addition, the variable aperture further includes a spring 5, with one end fixed relative to the rotating bracket 2 and the other end fixed relative to the base 1. In this way, when the rotating bracket 2 rotates relative to the base 1, the spring 5 undergoes elastic deformation accordingly, such that the spring 5 provides a restoring force for the relative rotation between the rotating bracket 2 and the base 1. As a result, the spring 5 can reduce friction between the rotating bracket 2 and the base 1, and can balance the driving force provided by the driving mechanism 4. Moreover, compared with the ball or roller bearings in the related art, the spring 5 used in the present disclosure has a relatively small variation in elastic coefficient during mass production, resulting in better consistency. Further, after long-term use or in situations involving external impact, the spring does not pose risks associated with variations in friction coefficient, thereby offering better stability and higher reliability.

Further, in some embodiments, the spring 5 extends circumferentially, with one end fixed relative to the base 1 and the other end fixed relative to the rotating bracket 2. In this way, the spring 5 can provide a circumferential restoring force, which can be balanced against the driving force from the driving mechanism 4.

Further, in some embodiments, the variable aperture includes a plurality of springs 5 arranged circumferential at intervals. Specifically, the spring 5 may not necessarily have a predetermined extension length, instead, a restoring force for the relative rotation between the rotating bracket 2 and the base 1 can also be achieved by circumferentially arranging multiple springs 5. It is understood that one end of each spring 5 is fixed relative to the base 1, and the other end of each spring 5 is fixed relative to the rotating bracket 2. Taking the two ends of each spring 5 as the left and right sides, for example, and with circumferential arrangement, the ends of the springs 5 fixed relative to the base 1 are all located on the same side, e.g., all on the left side or all on the right side, and the ends that are fixed relative to the rotating bracket 2 are correspondingly all located on the opposite side. In this way, the restoring force of the springs 5 can be effectively exerted.

Further, in some embodiments, the spring 5 may extend a certain length circumferentially. Additionally, multiple springs 5 may be arranged circumferentially to enhance the restoring force provided by the springs 5. Details in this regard are not repeated herein.

Further, in some embodiments, the driving mechanism 4 includes a magnet structure fixedly connected to the base 1, and a coil 43 sleeved around the magnet structure and fixedly connected to the rotating bracket 2. The coil 43 is configured to drive the rotating bracket 2 to rotate.

Specifically, in the driving mechanism 4 the magnet structure serves as the stator, and the coil 43 serves as the rotor. When being energized, the coil 43 drives the rotating bracket 2 to rotate. The rotating bracket 2, in turn, drives the blades 3 to rotate relative to the base 1 and slide relative to the rotating bracket 2. That is, the coil 43 can indirectly control the motion of the plurality of blades 3, thereby varying the size of the aperture hole formed by the blades 3, and consequently regulating the amount of incoming light. Furthermore, since the rotating bracket 2 is driven by the coil 43, and the coil 43 is lightweight, the motion of the coil 43 and the rotating bracket 2 is more responsive. This allows the variable aperture to have a quick start-up and stop during operation. Additionally, during the adjustment of the size of the aperture hole, the blades 3 follow the motion of the coil 43 and can rapidly reach the specified position, achieving a no-delay adjustment. Moreover, when the blades 3 reach the specified position to adjust the size of the aperture hole, the blades 3 may exhibit slight or no vibration at all, ensuring precise size of the aperture hole and reducing the running time and frequency of closed-loop control, thus saving power consumption.

Further, in other embodiments, the rotating bracket 2 is fixedly connected to the magnet, and the coil 43 is fixedly connected to the base 1. Similarly, when being energized, the coil 43 can drive the rotating bracket 2 to rotate relative to the base 1.

It should be understood that the driving mechanism 4 can also be another type of driving source. For example, the driving mechanism 4 may be a motor, with an output shaft of the motor connected to the rotating bracket 2 to drive the rotating bracket 2 to rotate.

Further, in some embodiments, an accommodating space 6 is formed between the base 1 and the rotating bracket 2, spaced from the first through hole 11. The driving mechanism 4 is at least partially assembled within the accommodating space 6. Additionally, a first sliding groove 12 is formed on the outer peripheral side of the base 1, extending circumferentially and communicating with the accommodating space 6. A first sliding block 22 protrudes from one side of the rotating bracket 2, facing the base 1, along the axial direction. The first sliding block 22 moves along the first sliding groove 12. The side of the coil 43 that faces radially away from the magnet structure is fixedly connected to the side of the first sliding block 22 facing the accommodating space 6.

Specifically, the base 1 includes a seat body arranged axially, a central portion protruding axially from the seat body, and a first side wall arranged on the peripheral side of the seat body. The first sliding groove 12 extends through the first side wall. The first through hole 11 extends through the central portion. The first side wall includes two spaced protruding structures, with the first sliding groove 12 formed between the two protruding structures. Additionally, the rotating bracket 2 includes a bracket body arranged axially and a second side wall arranged on the peripheral side of the bracket body. The first sliding block 22 is formed on the second side wall. The accommodating space 6 is formed between the outer side of the central portion, the inner side of the first side wall of the base 1, and the inner side of the second side wall of the rotating bracket 2. The coil 43 and the magnet structure of the driving mechanism 4 are arranged within the accommodating space 6. The coil 43 is fixedly connected to the inner side of the first sliding block 22 of the rotating bracket 2, thereby being fixed to the rotating bracket 2. Furthermore, when being energized, the coil 43 drives the rotating bracket 2 to rotate about the rotation shaft 14, which is centered on the first through hole 11, the second through hole 21, and the aperture hole 31. In this case, the first sliding block 22 moves within the first sliding groove 12, enabling the rotating bracket 2 to rotate relative to the base 1.

It should be noted that, in the embodiments of the present disclosure, the axial direction refers to the direction parallel to the central axis of the aperture hole 31.

Further, in some embodiments, a connecting protrusion 13 axially protrudes from the base 1 toward the rotating bracket 2. The connecting protrusion 13 is at least partially located within the accommodating space 6, and one end of the magnet structure is fixedly connected to the connecting protrusion 13.

Specifically, one of the protruding structures of the base 1 that is used to form the first sliding groove 12 may serve as the connecting protrusion 13. One end of the magnet structure may be fixedly connected to the connecting protrusion 13, for example, by adhesive bonding, thereby enabling a fixed connection between the magnet structure and the base 1. It should be understood that both protruding structures of the base 1 used to form the first sliding groove 12 may serve as two connecting protrusions 13, in which both ends of the magnet structure may be fixedly connected to the two connecting protrusions 13, respectively.

Additionally, in some specific embodiments, the magnet structure includes a chamfered structure, and the connecting protrusion 13 of the base 1 may be provided with a groove having a corresponding chamfered shape. In this manner, the magnet structure can fit more closely with the connecting protrusion 13, thereby improving the stability of the connection between the magnet structure and the base 1.

Further, in some embodiments, the spring 5 is partially accommodated within the accommodating space 6, and one end of the spring 5 serves as a movable end 51. The movable end 51 is fixedly connected to the side of the coil 43 that faces away from the first sliding block 22.

Specifically, the movable end 51 of the spring 5 may be fixedly connected to the side of the coil 43 that faces away from the first sliding block 22. Since the coil 43 is fixedly connected to the rotating bracket 2, the movable end 51 of the spring 5 can thus be fixedly connected to the rotating bracket 2 via the coil 43, thereby achieving a fixed connection between the movable end 51 of the spring 5 and the rotating bracket 2. In this way, while driving the rotating bracket 2 to rotate, the coil 43 also causes the spring 5 to undergo elastic deformation, such that the spring 5 can provide a restoring force for the relative rotation between the rotating bracket 2 and the base 1. As a result, the spring 5 can reduce the friction between the rotating bracket 2 and the base 1, and the elastic force of the spring 5 can be balanced against the driving force of the driving mechanism 4.

Further, in some embodiments, the variable aperture further includes a first electrical connection board 7. The first electrical connection board 7 includes a main body 71 arranged on the side of the base 1 axially facing away from the rotating bracket 2, and a first connecting portion 72 protruding from the main body 71 toward the rotating bracket 2. The first connecting portion 72 is located within the first sliding groove 12. The other end of the spring 5 serves as a fixed end 52, and the fixed end 52 is fixedly connected to the side of the first connecting portion 72 facing away from the accommodating space 6.

Specifically, the variable aperture further includes the first electrical connection board 7 configured to provide electrical power. The first electrical connection board 7 includes the main body 71 connected to the seat body of the base 1, and the first connecting portion 72 protruding in the axial direction. The first connecting portion 72 is arranged in the first sliding groove 12. The fixed end 52 of the spring 5 is fixedly connected to the first connecting portion 72 of the first electrical connection board 7, thereby realizing a fixed connection between one end of the spring 5 and the first electrical connection board 7. In addition, the first electrical connection board 7 is fixedly connected to the base 1, so that the fixed end 52 of the spring 5 can be fixed to the base 1 via the first connecting portion 72 of the first electrical connection board 7.

Further, in some embodiments, the rotating bracket 2 is provided on its outer circumferential side with a second sliding groove 23 extending circumferentially, and the base 1 is provided with a second sliding block configured to move along the second sliding groove 23. The first electrical connection board 7 further includes a second connecting portion 73, which protrudes from the main body 71 and is arranged parallel to and spaced apart from the first connecting portion 72. The second connecting portion 73 is fixedly connected to the side of the second sliding block facing away from the accommodating space 6.

Specifically, the first sliding block 22 may be arranged on the first side wall of the base 1, such that the second sliding block and the first sliding groove 12 are arranged on the base 1 with a spacing therebetween. The second sliding groove 23 may be arranged on the second side wall of the rotating bracket 2, such that the second sliding groove 23 and the first sliding block 22 are arranged on the rotating bracket 2 with a spacing therebetween. When being energized, the coil 43 drives the rotating bracket 2 to rotate. The first sliding block 22 moves within the first sliding groove 12, and the second sliding block moves within the second sliding groove 23, thereby enabling rotation of the rotating bracket 2 relative to the base 1. In addition, the first electrical connection board 7 may further include the second connecting portion 73 which is fixed to the outer side of the second sliding block, such that the second connecting portion 73 is exposed to the outside and can thus be used for connection with external devices.

It should be understood that, in some embodiments, only the second sliding groove 23 and the second sliding block can achieve the rotation of the rotating bracket 2 relative to the base 1.

Further, in some embodiments, the variable aperture further includes a second electrical connection board 8 fixedly connected to the side of the rotating bracket 2 facing the base 1 in the axial direction. The coil 43 is electrically connected to the second electrical connection board 8. The fixed end 52 of the spring 5 is electrically connected to the first connecting portion 72. The movable end 51 of the spring 5 is electrically connected to the coil 43.

Specifically, one of the first electrical connection board 7 and the second electrical connection board 8 may serve as the positive electrode, and the other may serve as the negative electrode. The coil 43 is electrically connected to the second electrical connection board 8. The first connecting portion 72 of the first electrical connection board 7 is electrically connected to the fixed end 52 of the spring 5. The movable end 51 of the spring 5 is electrically connected to the coil 43. In this way, the spring 5 enables electrical connection from the first electrical connection board 7, the coil 43, to the second electrical connection board 8, thereby enabling power supply to the coil 43. In other words, the spring 5 not only provides a restoring force to balance the driving force of the driving mechanism 4, but also serves as an electrical connection medium between the coil 43 and the first and second electrical connection boards 7 and 8. As a result, the spatial layout between the base 1 and the rotating bracket 2 can be optimized, reducing space occupation and overall size.

In addition, the fixed end 52 of the spring 5 is arranged on the outer side of the first connecting portion 72 of the first electrical connection board 7, and the second connecting portion 73 of the first electrical connection board 7 is arranged on the outer side of the second sliding block of the base 1. In this way, the first connecting portion 72 and the second connecting portion 73 of the first electrical connection board 7 can be used to connect with external circuits, thereby enabling the completion of the overall electrical circuit.

It should be understood that, since the second electrical connection board 8 is fixedly connected to the rotating bracket 2, the second electrical connection board 8 will also rotate as the rotating bracket 2 rotates after power is supplied. However, as the second electrical connection board 8, the coil 43, and the first electrical connection board 7 are electrically connected via the coil 43, the rotation of the second electrical connection board 8 does not affect the overall electrical circuit.

Further, in some embodiments, the magnet structure includes a first magnet 41 fixedly connected to the base 1 and a second magnet 42 arranged at one end of the first magnet 41, with the N poles of the magnets arranged oppositely. The driving mechanism 4 further includes a magnetic conductor 44, which is arranged on the side of the coil 43 facing away from the first magnet 41 and is fixedly connected to the base 1. The magnetic conductor 44 at least partially extends to the end of the second magnet 42 that faces away from the first magnet 41.

Specifically, the second magnet 42 is arranged at one end of the first magnet 41, such that the first magnet 41 and the second magnet 42 together form a bar-shaped magnet structure. Compared with a ring-shaped magnet structure, the spacing between the magnets in the bar-shaped configuration can be smaller, thereby generating a stronger magnetic field. In addition, the coil 43 is wound around the N pole of the first magnet 41. The N pole of the first magnet 41 and the N pole of the second magnet 42 are arranged opposite to each other. The magnetic conductor 44 is further arranged on the side of the coil 43 facing away from the first magnet 41, and at least a portion of the magnetic conductor 44 extends to the end of the second magnet 42 that faces away from the first magnet 41. With this arrangement, when the coil 43 is energized, the entire coil 43 is located within the effective region of the magnetic field. The magnetic fields generated by the first magnet 41 and the second magnet 42 can be concentrated at the coil 43, thereby improving magnetic field utilization and enhancing the driving force.

It should be understood that the first magnet 41 and the second magnet 42 are connected to form a bar-shaped magnet structure. When being energized, the coil 43 and the bar-shaped magnet structure will move relative to each other. As a result, the coil 43 can move to the N pole of the second magnet 42 or other positions. In other words, the connection position between the coil 43 and the bar-shaped magnet structure will dynamically change when the coil 43 is energized. However, the embodiments of the present disclosure mainly describe the connection position between the coil 43 and the bar-shaped magnet structure when the coil 43 is not energized.

Further, in some embodiments, the driving mechanism 4 also includes at least one magnetic steel. The magnetic steel is fixedly assembled between the first magnet 41 and the magnetic conductor 44, with the N pole of the magnetic steel facing the S pole of the first magnet 41.

Specifically, the magnetic conductor 44 is arranged on the outer circumferential side of the coil 43, facing away from the first magnet 41. There is an assembly gap between the magnetic conductor 44 and the first magnet 41. One or more magnetic steels are arranged in the assembly gap between the first magnet 41 and the magnetic conductor 44, with the N poles of the magnetic steels facing the S pole of the first magnet 41. With this arrangement, the magnetic field lines generated by the magnetic steels can overlap the magnetic field lines generated by the first magnet 41, thereby increasing the magnetic field strength and further enhancing the driving force.

It should be understood that the embodiments of the present disclosure do not limit the orientation of the two poles of the magnetic steel and the two poles of the first magnet 41. The orientation of the two poles of the magnetic steel and the two poles of the first magnet 41 can be adjusted by changing the arrangement of the magnetic steel between the first magnet 41 and the magnetic conductor 44. This can further adjust the degree of overlap between the magnetic field lines generated by the magnetic steels and those generated by the first magnet 41.

For example, in some specific embodiments, the two sides of the magnetic steel are fixed and attached to the outer surface of the first magnet 41 and the inner surface of the magnetic conductor 44, respectively, such that the orientation of the two poles of the magnetic steel is orthogonal to the orientation of the two poles of the first magnet 41. Specifically, the N pole of the magnetic steel faces the outer surface of the S pole of the first magnet 41, and the S pole of the magnetic steel faces the inner surface of the magnetic conductor 44. In this way, the magnetic field lines generated by the magnetic steel can overlap those generated by the first magnet 41, and the superposition can be enhanced, thereby improving the magnetic field strength and generating a stronger driving force.

Further, in some embodiments, the magnetic conductor 44 includes a first magnetic conduction sheet 441, which is arranged on the side of the coil 43 facing away from the first magnet 41. The first magnetic conduction sheet 441 extends along the lengthwise direction of the first magnet 41 and extends to the end of the second magnet 42, which faces away from the first magnet 41.

Specifically, the first magnetic conduction sheet 441 is arranged on the side of the coil 43 facing away from the first magnet 41. The first magnetic conduction sheet 441 is elongated and extends from one end of the first magnet 41 to the junction of the ends of the first magnet 41 and the second magnet 42, and then continues to extend to the other end of the second magnet 42. This arrangement ensures that the outer sides of both the first magnet 41 and the second magnet 42 are provided with magnetic conductor structures. As a result, the first magnetic conduction sheet 441 can concentrate the magnetic fields generated by the first magnet 41 and the second magnet 42, directing both magnetic fields towards the coil 43. This enhances the utilization of the magnetic fields and increases the driving force.

In other embodiments, the first magnetic conduction sheet 441 may extend from one end of the first magnet 41 to the junction of the ends of the first magnet 41 and the second magnet 42, and then continue to extend to the middle portion of the second magnet 42 along its length. This arrangement similarly concentrates the magnetic fields generated by both the first magnet 41 and the second magnet 42.

Further, in some specific embodiments, the first magnetic conduction sheet 441 may be fixedly attached to the seat body of the base 1 by adhesive bonding, thereby achieving a fixed connection between the magnetic conductor 44 and the base 1.

Further, in some embodiments, the driving mechanism 4 includes a first magnetic steel 45. The first magnetic steel 45 is fixedly assembled between the first magnet 41 and the first magnetic conduction sheet 441, with the N pole of the first magnetic steel 45 facing the S pole of the first magnet 41.

Specifically, an assembly gap exists between the first magnetic conduction sheet 441 and the first magnet 41. The first magnetic steel 45 is arranged in the assembly gap between the first magnetic conduction sheet 441 and the first magnet 41, with the N pole of the first magnetic steel 45 facing the S pole of the first magnet 41. As a result, the magnetic field lines of the first magnetic steel 45 overlap with the magnetic field lines of the first magnet 41, thereby enhancing the magnetic field strength.

It should be understood that the embodiments of the present disclosure do not limit the orientation of the poles of the first magnetic steel 45 and the orientation of the poles of the first magnet 41. By changing the configuration in which the first magnetic steel 45 is arranged between the first magnet 41 and the first magnetic conduction sheet 441, the orientation of the poles of the first magnetic steel 45 and the orientation of the poles of the first magnet 41 can be adjusted accordingly. As a result, the degree of superposition between the magnetic field lines generated by the first magnetic steel 45 and the magnetic field lines generated by the first magnet 41 can be adjusted.

For example, in some specific embodiments, the two sides of the first magnetic steel 45 are fixedly attached to the outer surface of the first magnet 41 and the inner surface of the first magnetic conduction sheet 441, respectively, such that the orientation of the poles of the first magnetic steel 45 is orthogonal to the orientation of the poles of the first magnet 41. That is, the N pole of the first magnetic steel 45 faces the outer surface of the S pole of the first magnet 41, and the S pole of the first magnetic steel 45 faces the inner surface of the first magnetic conduction sheet 441. In this way, the magnetic field lines generated by the first magnetic steel 45 can better superimposed with the magnetic field lines generated by the first magnet 41, thereby enhancing the magnetic field strength and generating a stronger driving force.

Further, in some embodiments, the magnetic conductor 44 further includes a second magnetic conduction sheet 442, which is connected to and arranged orthogonally to the first magnetic conduction sheet 441. The second magnetic conduction sheet 442 extends along the lengthwise direction of the first magnet 41 and extends to a middle part of the second magnet 42 along the lengthwise direction.

Specifically, the magnetic conductor 44 further includes a second magnetic conduction sheet 442 arranged orthogonally to the first magnetic conduction sheet 441. The second magnetic conduction sheet 442 also extends along the lengthwise direction of the first magnet 41. The second magnetic conduction sheet 442 extends from one end of the first magnet 41 to the junction between the first magnet 41 and the second magnet 42, and further extends to the middle part of the second magnet 42 along the length. In this way, the magnetic field lines generated by the first magnet 41 can be concentrated toward the coil 43, and the magnetic field lines generated by the second magnet 42 can also be guided toward the coil 43.

In other embodiments, the second magnetic conduction sheet 442 extends along the lengthwise direction of the first magnet 41 and further extends to the other end of the second magnet 42, which is away from the first magnet 41. That is, the second magnetic conduction sheet 442 extends from one end of the first magnet 41 to the junction between the first magnet 41 and the second magnet 42, and further extends to the other end of the second magnet 42. In this way, the magnetic field lines generated by the first magnet 41 can be concentrated, and the magnetic field lines generated by the second magnet 42 can be guided more effectively toward the coil 43.

Further, in some specific embodiments, the second magnetic conduction sheet 442 of the magnetic conductor 44 may be located in the first sliding groove 12 of the base 1. When the base 1 is connected to the rotating bracket 2, the second magnetic conduction sheet 442 is located on one side of the first sliding block 22 of the rotating bracket 2 along the axial direction, that is, one of the second magnetic conduction sheet 442 and the first sliding block 22 is located above the other along the axial direction. The second magnetic conduction sheet 442 of the magnetic conductor 44 may be fixedly connected to the first connecting portion 72 of the first electrical connection board 7. The fixed end 52 of the spring 5 may be fixedly connected to the side of the first connecting portion 72 facing away from the magnetic conductor 44. In this way, the connection stability among the second magnetic conduction sheet 442 of the magnetic conductor 44, the first connecting portion 72 of the first electrical connection board 7, the fixed end 52 of the spring 5, and the base 1 can be further improved.

Further, in some embodiments, the driving mechanism 4 further includes a second magnetic steel 46. The second magnetic steel 46 is fixedly assembled between the first magnet 41 and the second magnetic conduction sheet 442, and the N pole of the second magnetic steel 46 faces the S pole of the first magnet 41.

Specifically, there is an assembly gap between the second magnetic conduction sheet 442 and the first magnet 41. The second magnetic steel 46 is arranged in the assembly gap between the second magnetic conduction sheet 442 and the first magnet 41, and the N pole of the second magnetic steel 46 faces the S pole of the first magnet 41. In this way, the magnetic field lines generated by the second magnetic steel 46 and the magnetic field lines generated by the first magnet 41 can overlap, thereby enhancing the magnetic field strength.

It should be understood that the embodiments of the present disclosure are not limited to the orientation of poles of the second magnetic steel 46 and the orientation of poles of the first magnet 41. The arrangement of the second magnetic steel 46 between the first magnet 41 and the second magnetic conduction sheet 442 may be adjusted to change the orientation of poles of the second magnetic steel 46 and the orientation of poles of the first magnet 41, thereby adjusting the degree of overlap between the magnetic field lines generated by the second magnetic steel 46 and the magnetic field lines generated by the first magnet 41.

By way of example, in some specific embodiments, the second magnetic steel 46 is fixedly attached on both sides to the outer surface of the first magnet 41 and the inner surface of the second magnetic conduction sheet 442, respectively, such that the orientation of poles of the second magnetic steel 46 is orthogonal to the orientation of poles of the first magnet 41. Specifically, the N pole of the second magnetic steel 46 faces the outer surface of the S pole of the first magnet 41, and the S pole of the second magnetic steel 46 faces the inner surface of the second magnetic conduction sheet 442. In this way, the magnetic field lines generated by the second magnetic steel 46 and the magnetic field lines generated by the first magnet 41 can overlap better, thereby further enhancing the magnetic field strength and producing a stronger driving force.

Further, in some embodiments, the driving mechanism 4 further includes an iron core 47. The first magnet 41 and the second magnet 42 are connected via the iron core 47, and the coil 43 extends from the N pole of the first magnet 41 to an end of the iron core 47 away from the first magnet 41.

Specifically, the iron core 47 is also arranged between the first magnet 41 and the second magnet 42. The N pole of the first magnet 41 and the iron core 47 both pass through the coil 43, i.e., the coil 43 is wound around the N pole of the first magnet 41 and also around the iron core 47. Since the iron core 47 is made of a paramagnetic material with high magnetic permeability, when being inserted inside the energized coil 43 the iron core 47 becomes magnetized by the magnetic field of the energized coil 43, resulting in a significant increase in the magnetic flux density inside the iron core 47. The magnetized iron core 47 also acts as a magnet, and the magnetic field generated by the iron core 47 can overlap the magnetic fields generated by the first magnet 41 and the second magnet 42, thereby further enhancing the overall magnetic field strength and increasing the driving force.

Further, in some embodiments, the variable aperture includes a plurality of magnetic circuit structures spaced circumferentially on the base 1, such that their respective coils 43 simultaneously control a single rotating bracket 2, thereby enhancing the driving effect on the rotating bracket 2. Additionally, since the magnetic circuit structures are arranged at intervals, the circumferential driving forces acting on different portions of the rotating bracket 2 can be more balanced, thereby enabling smoother rotation.

Further, in some specific embodiments, the blades 3 each are provided with a rotation hole 32 and a sliding hole 33 spaced apart from the rotation hole 32. Rotating shafts 14 protrude axially from the center portion of the base 1, and connecting posts protrude axially from the bracket body of the rotating bracket 2. The rotation hole 32 of each blade 3 is sleeved onto the respective rotating shaft 14. The sliding hole 33 of each blade 3 is sleeved onto the respective connecting post. First, after the coil 43 is energized, the connecting post of the rotating bracket 2 interacts with the rotation hole 32 of each blade 3, such that the rotating bracket 2 drives the blades 3 to rotate. The rotation hole 32 of each blade 3 also rotates about the rotating shaft 14 of the base 1. As a result, the blades 3 rotate about the rotating shaft 14 of the base 1 and simultaneously slide relative to the rotating bracket 2 along the extension direction of the sliding hole 33, thereby allowing adjustment of the size of the aperture hole 31.

Further, in some embodiments, the variable aperture further includes a cover 9 fixed relative to the side wall of the base 1 and covering the side of the blade 3 facing away from the rotating bracket 2. The cover 9 is provided with a third through hole 91 aligned with the first through hole 11. In this way, the blades 3 can be protected, thereby increasing the service life of the variable aperture.

A camera module is also provided, which includes a lens module and a variable aperture. The variable aperture is fixedly connected to the lens module and is located on the near-light side of a lens of the lens module.

Specifically, the lens module includes the lens, and the variable aperture is fixed to the lens module and positioned on the near-light side of the lens. In this way, by adjusting the size of the aperture hole 31 of the variable aperture, the amount of light entering the lens can be adjusted, thereby enabling good imaging performance under various environmental conditions.

In addition, in the embodiments of the present disclosure, one end of the spring 5 of the variable aperture is fixed relative to the rotating bracket 2, and the other end is fixed relative to the base 1. In this way, when the rotating bracket 2 rotates relative to the base 1, the spring 5 undergoes elastic deformation accordingly, such that the spring 5 provides a restoring force for the relative rotation between the rotating bracket 2 and the base 1. As a result, the spring 5 reduces the friction between the rotating bracket 2 and the base 1 and balances the driving force provided by the driving mechanism 4. Compared with the ball or roller bearings in the related art, the spring 5 in the present disclosure exhibits less variation in elastic coefficient during mass production and thus better consistency. Furthermore, even under long-term use or external impacts, the spring 5 does not pose a risk of friction coefficient fluctuation, offering high stability and reliability. This is advantageous for adjusting the amount of light entering the lens and improving the reliability of the camera module.

Further, in some specific embodiments, the surfaces of the plurality of blades 3 are polished or smoothed, thereby reducing friction and preventing the generation of fine debris caused by long-term friction, which could otherwise contaminate the lens.

An electronic device is also provided, which includes a camera module.

By way of example, the electronic device may be a mobile phone, a tablet, a camera, or the like. In the embodiments of the present disclosure, one end of the spring 5 of the variable aperture is fixed relative to the rotating bracket 2, and the other end is fixed relative to the base 1. In this manner, when the rotating bracket 2 rotates relative to the base 1, the spring 5 correspondingly undergoes elastic deformation, thereby providing a restoring force for the relative rotation between the rotating bracket 2 and the base 1. As a result, the spring 5 can reduce the friction between the rotating bracket 2 and the base 1 and balance the driving force from the driving mechanism 4. In addition, compared with the ball or roller bearings in the related art, the spring 5 in the embodiments of the present disclosure exhibits less variation in elastic coefficient during mass production, thereby providing better consistency. Furthermore, even under long-term use or external impacts, the spring does not pose a risk of friction coefficient fluctuation, offering high stability and reliability. This facilitates adjustment of the amount of light entering the lens of the electronic device and improves the reliability of the electronic device.

This description merely illustrates embodiments of the present disclosure. It should be noted that, modifications and improvements may be made by those skilled in the art without departing from the inventive concept of the present disclosure, and all such modifications and improvements shall fall within the scope of protection of the present disclosure.

1. A variable aperture, comprising:
a base;
a rotating bracket rotatably connected to the base;
a plurality of blades rotatably connected to the base and slidably connected to the rotating bracket; and
a driving mechanism for driving the rotating bracket to rotate, wherein the base is provided with a first through hole, the rotating bracket is provided with a second through hole, and the plurality of blades together define an aperture hole, with the first through hole, the second through hole, and the aperture hole being aligned; and
wherein the variable aperture further comprises a spring, with one end of the spring is fixed relative to the rotating bracket, and the other end of the spring is fixed relative to the base, and the spring is configured to provide a restoring force to drive the rotating bracket to rotate circumferentially.

2. The variable aperture according to claim 1, wherein the spring extends circumferentially, and/or the variable aperture further comprises a plurality of such springs arranged at circumferential intervals.

3. The variable aperture according to claim 1, wherein the driving mechanism comprises:
a magnet structure fixedly connected to the base; and
a coil arranged around the magnet structure and fixedly connected to the rotating bracket, and configured to drive the rotating bracket to rotate.

4. The variable aperture according to claim 3, wherein
an accommodating space is formed between the base and the rotating bracket, spaced apart from the first through hole, and the driving mechanism is at least partially assembled in the accommodating space;
the base is provided with, at its outer circumferential side, a first sliding groove in communication with the accommodating space and extending circumferentially;
a first sliding block protrudes axially from the rotating bracket toward the base, and is configured to move along the first sliding groove; and
the coil is fixedly connected, on a side facing the accommodating space, to a side of the first sliding block that radially faces away from the magnet structure.

5. The variable aperture according to claim 4, wherein a connecting protrusion protrudes axially from the base toward the rotating bracket, the connecting protrusion is at least partially located within the accommodating space, and one end of the magnet structure is fixedly connected to the connecting protrusion.

6. The variable aperture according to claim 4, wherein the spring is partially accommodated in the accommodating space, and one end of the spring is a movable end and fixedly connected to a side of the coil that faces away from the first sliding block.

7. The variable aperture according to claim 6, wherein the variable aperture further comprises a first electrical connection board, and the first electrical connection board comprises:
a main body arranged on a side of the base that axially faces away from the rotating bracket; and
a first connecting portion protruding from the main body toward the rotating bracket, wherein the first connecting portion is located within the first sliding groove, and the other end of the spring is a fixed end fixedly connected to a side of the first connecting portion that faces away from the accommodating space.

8. The variable aperture according to claim 7, wherein the rotating bracket is provided on its outer peripheral side with a second sliding groove extending circumferentially, the base is provided with a second sliding block configured to move along the second sliding groove; the first electrical connection board further comprises a second connecting portion protruding from the main body, the second connecting portion is arranged in parallel with and spaced apart from the first connecting portion, and the second connecting portion is fixedly connected to a side of the second sliding block that faces away from the accommodating space.

9. The variable aperture according to claim 7, wherein the variable aperture further comprises a second electrical connection board fixedly connected to a side of the rotating bracket that axially faces the base, wherein the coil is electrically connected to the second electrical connection board, the fixed end is electrically connected to the first connecting portion, and the movable end is electrically connected to the coil.

10. The variable aperture according to claim 3, wherein the magnet structure comprises a first magnet fixedly connected to the base, and a second magnet arranged at one end of the first magnet such that N poles of the first and second magnets face each other; and
the driving mechanism further comprises a magnetic conductor arranged on a side of the coil that faces away from the first magnet and fixedly connected to the base, wherein the magnetic conductor at least partially extends to an end of the second magnet that faces away from the first magnet.

11. The variable aperture according to claim 10, wherein the driving mechanism further comprises at least one magnetic steel fixedly assembled between the first magnet and the magnetic conductor, and an N pole of the magnetic steel faces an S pole of the first magnet.

12. The variable aperture according to claim 10, wherein the magnetic conductor comprises a first magnetic conduction sheet arranged on the side of the coil that faces away from the first magnet, and the first magnetic conduction sheet extends in a lengthwise direction of the first magnet and extends to the end of the second magnet that faces away from the first magnet.

13. The variable aperture according to claim 12, wherein the driving mechanism comprises a first magnetic steel fixedly assembled between the first magnet and the first magnetic conduction sheet, and an N pole of the first magnetic steel faces an S pole of the first magnet.

14. The variable aperture according to claim 12, wherein the magnetic conductor further comprises a second magnetic conduction sheet connected to and arranged orthogonally with the first magnetic conduction sheet, wherein the second magnetic conduction sheet extends in the lengthwise direction of the first magnet and extends to a middle part of the second magnet along the lengthwise direction.

15. The variable aperture according to claim 14, wherein the driving mechanism further comprises a second magnetic steel fixedly assembled between the first magnet and the second magnetic conduction sheet, and an N pole of the second magnetic steel faces the S pole of the first magnet.

16. The variable aperture according to claim 10, wherein the driving mechanism further comprises an iron core, the first magnet and the second magnet are connected via the iron core, and the coil extends from the N pole of the first magnet to an end of the iron core that faces away from the first magnet.

17. A camera module, comprising a lens module and the variable aperture according to claim 1, wherein the variable aperture is fixedly connected to the lens module and is located on a near-light side of a lens of the lens module.

18. An electronic device, comprising the camera module according to claim 17.
